(19) United States
(12) Patent Application Publication
(10) Pub. No.: US 2014/0149319 A1
(43) Pub. Date: May 29, 2014

(54) Selling Income from Tax Deferred Investments

(71) Applicant: Mark Greenstein, Bethesda, MD (US)

(72) Inventor: Mark Greenstein, Bethesda, MD (US)

(21) Appl. No.: 14/088,593

(22) Filed: Nov. 25, 2013

Related U.S. Application Data
(60) Provisional application No. 61/729,759, filed on Nov. 26, 2012.

(51) Int. Cl. G06Q 40/06; G06Q 40/00

(52) U.S. Cl. CPC G06Q 40/06; G06Q 40/10
USPC 705/36 T

(57) ABSTRACT

A machine manufacture, process, composition and product produced thereby. Representatively there can be a computer-aided method for assigning and managing the rights to receive taxes when amounts are disbursed from tax-advantaged accounts for which a prior deduction has been received, the method including the input of data and incorporation of contract terms which determine the amounts and timing of the right to receive taxes when amounts are disbursed.

This application is a nonprovisional of U.S. Provisional Patent Application No. 61/729,759, filed on Nov. 26, 2012, the disclosure of which is hereby incorporated by reference to the extent not inconsistent with the present disclosure. Also, application No. 61/1775,845, filed Mar. 11, 2013, the disclosure of which is also hereby incorporated by reference to the extent not inconsistent with the present disclosure and priority is claimed to such application.

### BACKGROUND OF THE INVENTION

### Technical Field of the Invention

The present invention pertains to machine, manufacture, process, composition, and product produced thereby, as well as necessary intermediates.

### BRIEF DESCRIPTION OF THE DRAWINGS

FIG. 1 is a graphic representation of the principal actors in the invention.

FIG. 2 is a flowchart showing the data input.

FIG. 3 is a diagram representing the computer system in accordance with the invention.

FIG. 4 is a flowchart showing the exchange of consideration for the right to receive taxes and the payment of such right to receive taxes.

FIG. 5 is a flowchart showing how the right to receive taxes can be divided into different interests.

### DETAILED DESCRIPTION

The system for recording the budget costs in the United States when some part of all of amounts deemed expended will be recovered in the future is flawed when such future amounts will be received outside of the budget window. An example of such flaw is where contributions to vehicles where the tax is deferred but not eliminated such as those amounts generally contributed to qualified retirement plans in the United States is seriously flawed in that it does not account for taxes owed and generally paid when said contributions, and investment returns on such contributions are removed from tax-favored vehicles.

Previous attempts to reflect such amounts in current revenue teach away from that which is disclosed in this specification and have been limited in the application and effectiveness. For example, see the following from the article which is submitted supporting this specification.
Well, Congress in the season of giving has provided plan sponsors and participants with multiple beneficial opportunities to start 2013. Congress passed the American Taxpayer Relief Act of 2012 (H.R. 8), also known as the “Fiscal Cliff” legislation, on January 1, 2013, and President Obama signed the legislation on January 2, 2013. This legislation significantly expands the ability for participants to convert non-Roth accounts within 401(k), 403(b), and 457(b) governmental plans to Roth accounts without withdrawing amounts from the plan. This provision is expected to raise $12.2 billion over 10 years to offset the loss of revenue stemming from the sequestration delay

As noted this had a limited effect (12.2 billion) and depends upon action by individuals converting their accounts to Roth accounts and paying taxes currently on the amounts converted.

Further lobbyists have been active in attempting to preserve the tax advantages of retirement account tax breaks. They emphasize that amounts which receive deductions are not a true economic expense, but are recovered at a later date.

These efforts are ongoing and substantial. For example, a material portion of the last two annual meetings of the American Society of Pension Professionals and Actuaries was spent exhorting the members to lobby to preserve the tax benefits applicable to pension plans. The leadership organized bus trips to Capitol Hill to lobby for the preservation of the tax breaks at both meetings. The thrust of the argument was that our tax breaks are different from and more important than those provided to others and therefore should be preserved,

The leader of the organization stated at one of the meetings that while some in Congress acknowledged that the money is returned and that this makes this tax break different, they still need the money now. This causes budget policy to control pension policy, which is not favorable. in a prior congress it caused substantial cutbacks in the tax benefits provide for savings for retirement. It is this outcome that ASPPA members hope to avoid.

The attached Congressional Budget Office option paper, published in November, 2013, shows this thinking has not changed. Option 14 at page 133 examines the option of reducing the budget deficit by reducing tax benefits associated with private pension plans.

The present disclosure addresses this problem in a much different manner by providing for transferring the right to receive taxes due then such amounts are withdrawn from tax-deferred solution in exchange for current consideration such as money. This enables such amounts anticipated in the future to be presently reflected on the budget of the government. In fact, if tax rates are assumed to be constant and investment returns exceed the cost to the United States of interest to be paid over that same period, the sale of anticipated receipts could generate a profit, for budget purposes, as investors could be willing to pay more than the current cost of providing a tax benefit in the form of an income tax deduction. This could be the case even if tax rates are lower upon distribution, because the historical investment return of amounts in individual account plans such as section 401(k)-type plans is substantially higher than the long-term borrowing cost of the United States. Further, the government could make such outcome more likely and predictable by fixing the rate of taxes on disbursements, for example, at the time of a deduction and at the same rate as was used to calculate the deduction.

There could also be sales based on amounts already having received tax benefits, and the taxes that will be owed on such amounts, based on transfers from such accounts in the future. This could have beneficial effects on the present budget.

In any event, there will have to be adjustments made for the funds that go into and out of these vehicles on a regular basis. For example, amounts are regularly contributed to tax-qualified pension plans in the United States and amounts are regularly disbursed. The present disclosure suggests and reveals a mechanism for accounting for the attribution of newly contributed amounts so that taxes when such amounts are disbursed can be sold to new purchasers without affecting the rights of prior purchasers.

One way of doing this would be to sell the amounts collected based on taxation of amounts in specific years, for example one or more years 10 or more years in the future or estimated to be withdrawn 10 years of more in the future. The contacts for sale of the amounts collected would generally or always provide for an adjustment based on amounts placed in, and withdrawn from these vehicles each year. For example, if there were 100 dollars in such accounts and a net of 10 were added, the interests of the prior purchasers could be reduced by 10 divided by 110. Generally or in all cases, the rights purchased by subsequent purchasers would be subject to the rights of the earlier purchasers. Also the timing of the attribution of amounts withdrawn between investors would have to be specified in the contracts which sell the rights to taxes on the amounts disbursed. Such adjustments could be informed based on estimates and/or studies estimating when contributed amounts are withdrawn. The adjustments would generally or always be specified in advance so that there is certainty for the investors.

For example, as noted above the interests each year could be adjusted for the amounts placed in or taken out of vehicles. As between the investors, new investors in a year would generally be allocated a proportionate interest in taxes to be received based on the net increase in amounts in such vehicles adjusted for disbursements from the vehicles. The contracts assigning the rights to receive money when amounts are withdrawn could also specify an order of timing so that when amounts are withdrawn and the tax collected, the identity of the investor who is owned amounts, the timing of the right to receive the amounts and the determination of how much should be receive is known.

Perhaps the simplest mechanism to divide interests between investors would be to assume that all investors receive proportionate amounts due under the contract, unless otherwise specified. However, if it provides a commercial advantage, amounts could be divided or sold in differing amounts and interests either by the government or by investors who have purchased interests based on amounts to be received by reason of withdrawals from tax-deferred vehicles.

Amounts sold could be divided into different interests or tranches such as one based on equity returns in various markets as the amount received will depend, in part on such returns because of corresponding investment in the accounts. The investments in the accounts could be tracked and or projected, individual or collectively or a combination of both in order to provide a more accurate means to estimate/formulate the sale of different tranches which correspond to such returns.

In the case of defined benefit plans, the amount coming out of such accounts in largely formulaic, based on the terms of each plan and subject to applicable rules contained in the Internal Revenue Code and the timing is therefore somewhat more predictable. Therefore, this provides an opportunity for investors who would appreciate a more predictable stream of income. In fact, defined benefit plans are often interested in matching their investments to their liabilities. Therefore, such plans could be interested in purchasing taxes due from distributions from their own plans, as this would accomplish their goals of matching investment returns to their projected expenses.

While the amount of such returns is uncertain, the holder(s) and or the seller (Government) could swap or purchase swap contacts which would, together with the receipts, result in standardized and certain contracts, e.g., the return of the S and P 500.

What the Government Sells

The taxing authority, (typically the Government/Treasury or IRS) would sell the revenues it receives by reason of the disbursements from the tax-deferred accounts. Investors would be generally willing to bear the risks related to investment returns and the uncertainty of timing or could generally hedge such risks for example by selling investment returns based on an index which matched all or a portion of the investments held by plans where the amount of disbursements depend on the investment return (e.g., 401(k) plans). However, investors would generally not be willing to bear risks associated with government controlled actions, such as lowering the tax rates paid by reason of disbursements from such plans. Therefore, it is anticipated that the contract for the sale of the consideration received by reason of disbursements from such accounts will be generally based on conditions prevailing at the time of the sale. The contract will provide for appropriate/negotiated adjustments due to subsequent actions by the seller, such as changing the tax laws. For example, in such cases the seller could remain responsible to pay out amounts based on the conditions, including the tax rates, which were the case at the time of the sale.

This could means that if new tax laws provided for increased taxes, the seller could collect the increase or also sell it. If it decreased taxes it could be liable for the shortfall. Other adjustments could be provided in the contract based on applicable market conditions at the time of the sale.

As used herein, the term “computer” generally refers to hardware or hardware in combination with one or more program(s), such as can be implemented in software. Computers can be implemented as general-purpose computers, specialized devices, or a combination of general-purpose and specialized computing devices. Computing devices can be implemented electrically, optically, quantumly, biologically, and/or mechanically or in any combination of these technologies. A computer as used herein can be viewed as at least one computer having all functionality or as multiple computers with functionality separated to collectively cooperate to bring about the functionality. This includes single processor and multi-processor implementations of a computer. A processor can include any device that processes information or executes instructions. Computer logic flow and operations can be used in processing devices, including but not limited to: signal processors, data processors, microprocessors, and communication processors. Logic flow can be implemented in discrete circuits, combinational logic, ASICs, FPGAs, reconfigurable logic, programmed computers, or an equivalent.

Computer-readable media or medium, as used herein, includes any technology that includes a characteristic of memory. Memory technologies can be implemented using magnetic, optical, mechanical, or biological characteristics of materials. Common examples of memory are RAM, ROM, PROM, EPROM, FPGA, and floppy or hard disks. Communications medium or connection, as used herein, is any pathway or conduit in which information can be communicated or exchanged. The pathway or conduit can be wired, optical, fluidic, acoustic, wireless, or any combination of the foregoing.

The computer system can include one or more computers, which illustratively can be PC systems or server systems, and any combination of the foregoing. Depending on the implementation, computers can be adapted to communicate among themselves, or over a network such as the Internet. Programs, as used herein, are instructions that when executed by a processing device causes the processor to perform specified operations. Programs can be written in various languages, including but not limited to assembly, COBOL, FORTRAN, BASIC, C, C++, or Java. Languages can be object oriented like C++ and Java, for example. The programming language can be interpretive or compiled, or a combination of both. The programs are usually processed by a computing system having an operating system. An operating system can be processor specific, like an RTOS (real time operating system) used in cell phones, or commercial like OSX, UNIX, Windows, or LINUX. An operating system or program can be hardwired, firmware, reside in memory or be implemented in an FPGA or reconfigurable logic.

For example, a computer system can comprise a computer (e.g., an IBM, Hewlett Packard, MAC, or other personal computer) with one or more processors (e.g., an Intel or AMD series processor or the like), a memory (e.g., RAM, a hard drive, disk drive, etc.), one or more input devices (e.g., keyboard, mouse, modem, or the like), and one or more output devices (e.g., a modem, a

Hewlett Packard printer, a Dell monitor, or other such output device). Note that the modem is representative of a computer-to-computer communication device that can operate as an input/output device. To provide other illustrative embodiments, the computer system can comprise at least one of a desktop computer, a telephonic device, a console, a laptop computer, and a mobile communication device. The mobile communication device can comprise at least one of a cellular telephone, laptop, a PDA, and an IPhone-type device. Communications between devices may be wired, for example cabled Ethernet based home or office network, wireless through IEEE 802.11a/b/g network cards or Bluetooth, or optical through an IR port. Networking between devices may be through WANs, LANs, Intranets, Internet or peer-to-peer arrangements, or in a combination of them. Networks may include, for example, gateways, routers, bridges, switches, front end and back end servers, IPS (Internet service providers), content provider servers, scanners, copiers, printers and user computing devices. Devices on the network may include interfaces that can be as simple, such as a keyboard with an LCD screen, or can be complex, such as a web interface. Web interfaces are presented in a web browser environment. Web browsers render XML or HTML containing pictures and links in a window on the desktop, for example like Windows XP. Firefox, Mozilla, Internet Explorer, and Safari are examples of well-known web browsers.

Tax-advantaged or tax deferred vehicles refers to vehicle where taxes are owed when amounts are removed from such vehicles. Such removal includes disbursements as well as transfers to Roth accounts.

The above noted and other objects and/or advantages improve over the prior art as can be appreciated from the more detailed discussion that follows:

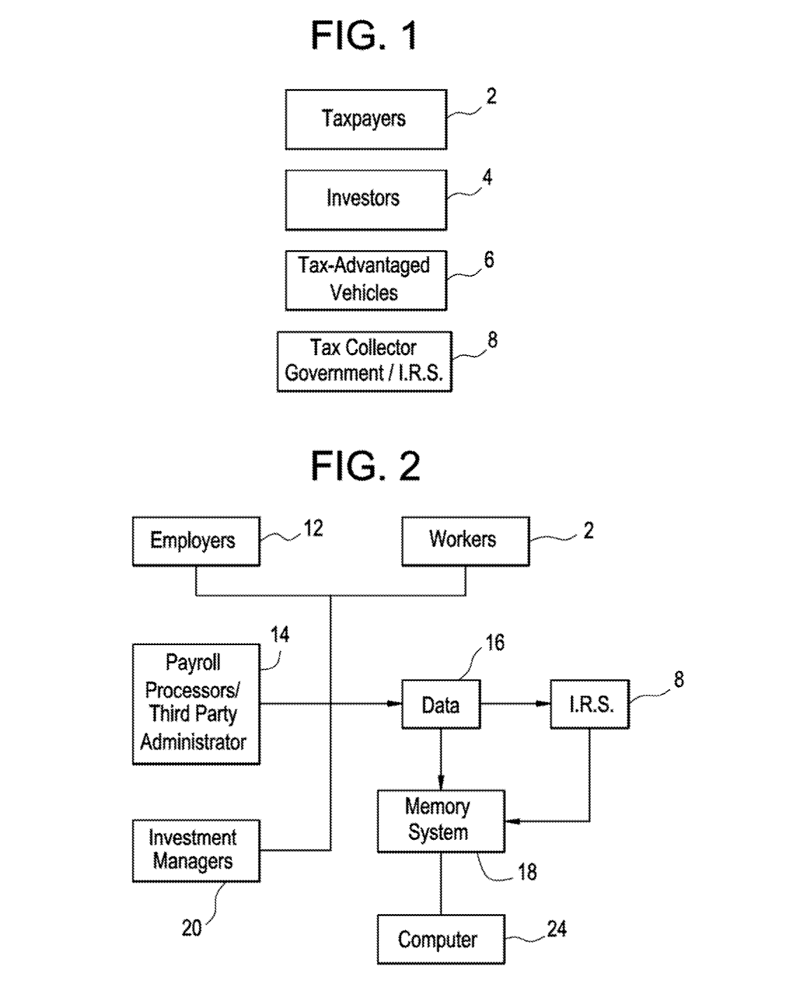

FIG. 1 illustrates the principal actors of the present disclosure. They are taxpayers 2, investors 4, tax-advantaged (or tax-deferred) vehicles 6 and the tax collector 8.

FIG. 2 illustrates how data concerning amounts placed in tax-deferred vehicles is recorded. Employers/Plan Administrators 12, payroll processors/third party administrator 14, each of which may receive input data from investment management firms 26 assigning investment returns workers 20 input data 16 which is transmitted to the IRS 22 and recorded by the IRS 22 as well as one or more of the other parties in a memory system 18 attached to a computer

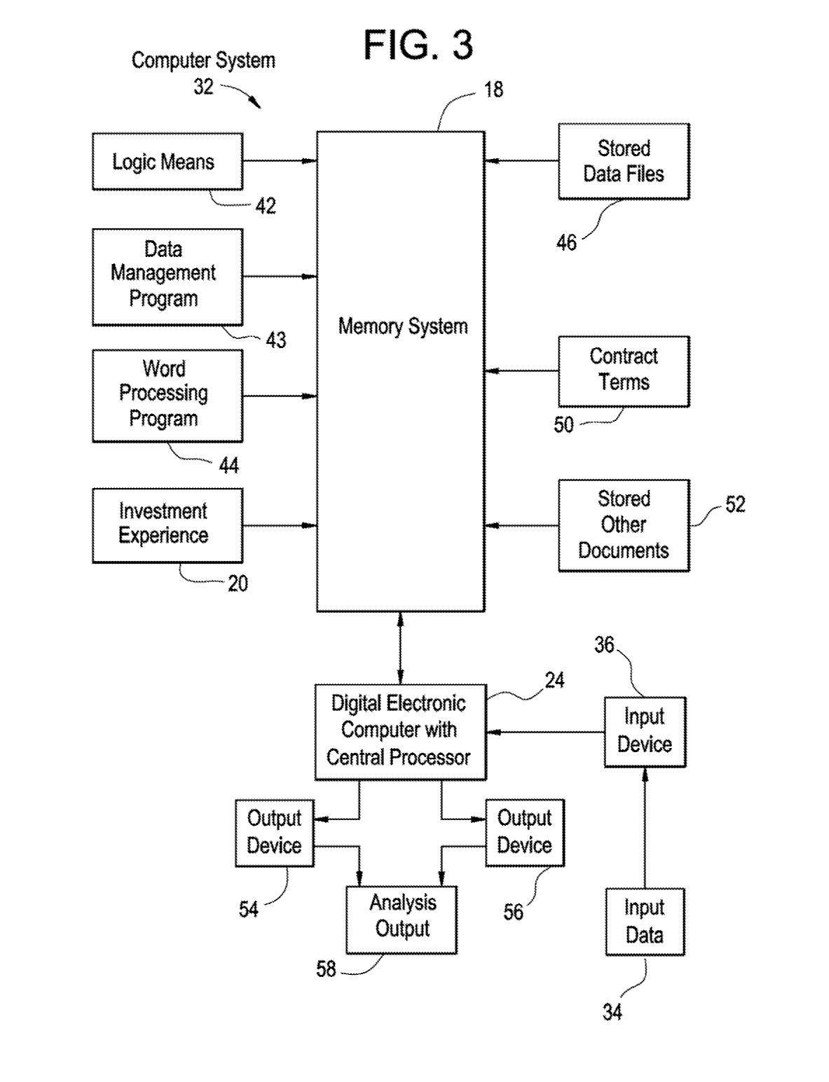

FIG. 3 provides a graphic presentation of the computer system for managing the sale of amounts due from when transfers are made from tax-advantaged vehicles. The present invention is directed to a Computer System 32 (i) that manipulates digital electrical signals consisting of (a) Input Data 34 pertaining to the contractual obligations 50, (b) Stored Documents 52, and (c) previously encoded and processed data Stored Data Files 16; (ii) that transforms these signals into an analysis of the data and contractual obligations 50; (iii) that uses this analysis to record the timing and amount of consideration due each investor 4 and adjust the interests of different investors 4 based on amounts owed and transferred; (iv) that documents the results in an Analysis Output 58, and (v) that illustrates selected results in Processed Model Documents 60,

The Computer System 32 includes a Digital Electronic Computer with Central Processor 38, a Memory System 40, an Input Device 36, and preferably two output devices, Output Device 54 and Output Device 56. The Memory System 40 includes an operating system Logic Means 42 to run the Computer System 32 and applications software. For example, the operating system could be Microsoft XP Professional that would allow use of its applications software such as Microsoft EXCEL, ACCESS, and WORD, The Memory System 40 includes (a) a Word Processing Program 44 such as Microsoft Word to generate Processed Model Documents 60 using data, assumptions, and results, and (b) a Data Management Program 43 such as Microsoft EXCEL or ACCESS to manage and evaluate data files. The Input Device 36 such as a keyboard receives Input Data 34 either manually or electronically. Output Device 54 and Output Device 56, such as a printer or a CD drive; produce such relevant documents as the I Analysis Output 58, including the input data, processed results, and other relevant information as well as processing logic, is normally shared via a network of computers.

Input data 34, usually in the form of files, includes: List of the amounts in tax-deferred vehicle and, in some cases, how these amounts are invested. It can also include data associated with the likely time when amounts will be disbursed including minimum distribution rules. It will also include the terms of the sales contract under which the taxing authority transfers the right to taxes on disbursements identifying and calculating of the timing and amount of taxes which disbursements are subject to the agreement based on disbursements. It will also include other transaction data including identification of person owed amounts under the contract as well as how much and when they are owed such amounts based on disbursements from tax-deferred accounts, including adjustments due to amounts paid and amounts added to tax-advantaged accounts.

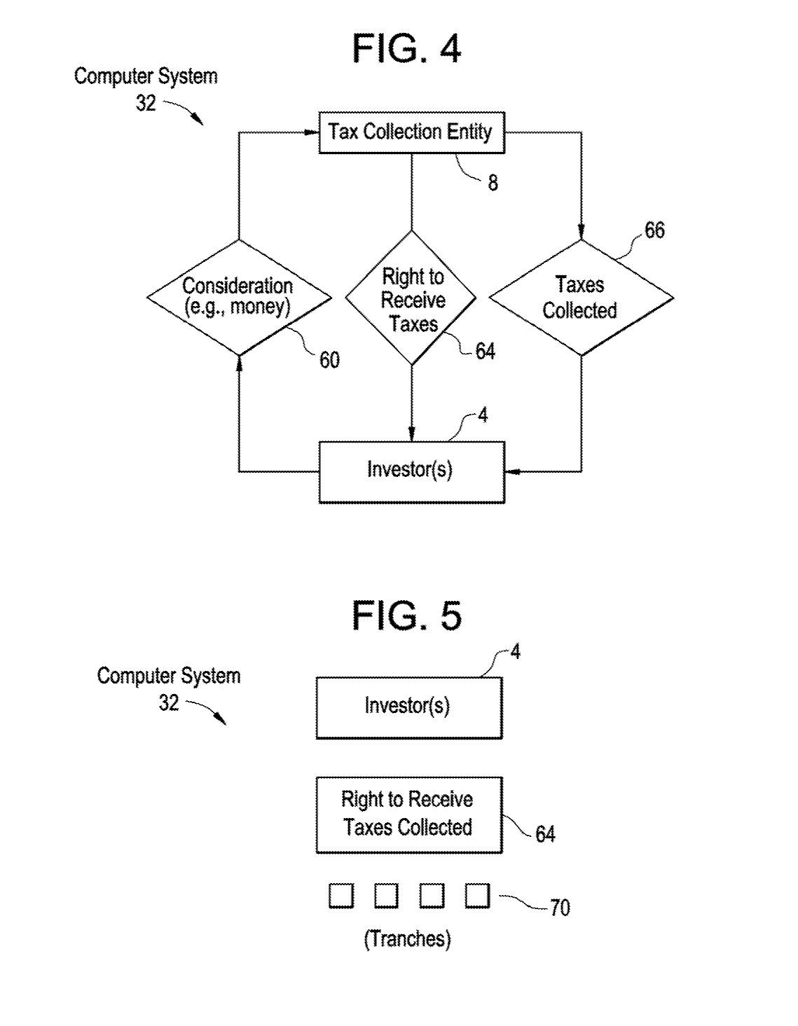

FIG. 4 illustrates the transfer of the Right to Receive Taxes 64 from the Tax Collector 8 to the Investor(s) 4 as well as the transfer of consideration 64 to the Tax Collector 8 for such Rights to Taxes 64. FIG. 4 also shows the payment of Consideration Due under the Contract 66 from the Tax Collector 8 to the Investor(s). This is accomplished using the Computer System 32 described in FIG. 3.

FIG. 5 illustrates how Rights to Receive Taxes from the Tax Collector 8 may be subdivided into different Tranches 70. For example, some investors might prefer to be certain of payment and receive a lower rate of return given the uncertainty of the amount and timing of disbursements. Others might wish to take greater risk, effectively betting, for example on increased longevity and therefore greater payments of taxes on account of disbursements from such plans. Still others may prefer a more customized payout. For example a defined benefit plan might wish to purchase taxes paid on amount disbursed from itself and such payments will match up well against liabilities. This is accomplished using the Computer System 32 described in FIG. 3.

Note that systems and/or methods employing one or more aspects of the present disclosure may, for example, be implemented using one or more systems and/or methods disclosed in Patent Application Pub. No US200210169701, entitled “Systems and Methods for Improving Investment Performance”, filed on Feb. 11, 2002, which is hereby expressly incorporated by reference into the present application to the extent not inconsistent with the present disclosure. As well application number 20110087623, filed Aug. 5, 2010 is also hereby expressly incorporated by reference into the present application, to the extent not inconsistent with the present disclosure. patent application Ser. No. 12/148,290 is also hereby expressly incorporated by reference into the present application, to the extent not inconsistent with the present disclosure

While the present invention has been explained in reference to the disclosed embodiments, it is to be understood that other modifications and or variations can be made without departing from the scope of the invention.

Note one computer in this over-all system of cooperation can be at any geographic location or jurisdiction. For example, a consumer's computer can be in, say, the US; the intermediary computer or a web site (server) can be in the US; the carrier (or other entity) can be in the US, and indeed the computer support for a foreign carrier can be in the US; the entity facilitating an embodiment herein can be in the US; the corporation or entity doing the regulatory compliance or forming the earnings, tax, income or other reporting can be in the US—with or without the others of these being in the US (in this example, US as a jurisdiction is exemplary only as the principle of computers located distinctly is intended to be more generally applicable.

Note that the preceding is a prophetic teaching and although only a few exemplary embodiments have been described in detail herein, and given the teaching, those skilled in the art will readily appreciate that many modifications are possible in the exemplary embodiments without materially departing from the novel teachings and advantages herein.

Accordingly, all such modifications are intended to be included within the scope herein. Note too that the language herein is intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

The invention claimed is:

1. One or more computers with associated software programmed to: receive, at a processor and store using one or more storage devices employing memory, data corresponding to invested amounts placed in one or more tax-advantaged vehicles; to reflect an exchange of the right to receive consideration based on the removal of such amounts from tax-deferred vehicles for other consideration; using one or more computers with associated software and employing one or more storage devices employing memory to track and store data associated with the such exchange, including at least the identity of the record owners of the rights to receive amount owed by reason of the removal from such vehicles; and the basis for determining the amount and timing of any consideration owed to such record owners.

2. Claim 1, wherein at least one computer with associated software and a storage device using memory is used to disburse consideration to the record owners when consideration is paid by reason removal from such tax-advantaged vehicles.

3. Claim 1, wherein the rights to receive amounts are affected by the performance of the investments made in such tax-advantaged vehicles.

4. Claim 1, wherein at least some of the rights to receive money or other consideration are placed in a collective investment vehicle and interests in the collective vehicle are sold to investors using a computer and storage device to track such sales and interests.

5. Claim 1, wherein the investment return varies based on the rates of taxation on the disbursements applicable to person who receive the amounts.

6. Claim 4, wherein a computer and related software are used to track and administer the investments in the collective vehicle when interests in the collective vehicle are divided in to different interests, with different rates of return.

7. Claim 6, wherein the timing of the right to receive amounts depends upon actions of the person who receives disbursements.

8. Claims 1, wherein the rights to receive amounts are related to disbursements from a defined benefit plan.

9. Claim 1 wherein the right to receive amounts are affected by the rates of taxation applicable to persons who receive the distributions.

10. Claim 1 wherein the tax-deferred vehicles are defined in section 4975(e)(1)(A)-(C) of the Internal Revenue Code, as these section existed on Nov. 1, 2013.

11. A method of using a computer system to manage the right to receive consideration by one or more investors due to the withdrawal of amounts from tax-deferred vehicles, the method including: accessing, by an electrical computer, data corresponding to amounts withdrawn from such vehicles; determining, by an electrical computer, the amount owed by reason of the withdrawal of amounts from tax-deferred vehicle; determining, by an electrical computer, how much of the amount owed is owned by each of one or more investors; distributing the amount owed to one or more investors; and, accounting, by an electrical computer, the remaining ownership of one or more investors in amounts owed due to distribution from tax-deferred vehicles after the distribution of amounts owed.

12. The method of 11, wherein the rights to receive consideration are further divided into different interests.

13. The method of claim 11 wherein the tax-deferred vehicles are defined in section 4975(e)(1)(A)-(C) of the Internal Revenue Code, as these section existed on Nov. 1, 2013.

14. The method of claim 11 wherein the rights to receive amounts are affected by the performance of the investments made in such tax-advantaged vehicles

15. A computer system configured to manage cash flows from the right to receive consideration by one or more investors due to the withdrawal of amounts from tax-deferred vehicles, the apparatus including: a computer system engaged to facilitate the receipt of such consideration the transaction having one or more first parties owing amounts from expected flows of consideration to one or more second parties, the computer system receiving data corresponding to withdrawals from such vehicles, calculating the consideration owed based on withdrawals from such vehicles, calculating the consideration owed to one or more investors by reason of such withdrawals, distributing the consideration to one or more investors, and calculating the remaining ownership based on consideration withdrawn from tax-deferred vehicles after distribution of such consideration.

16. An apparatus configured to manage cash flows from the right to receive consideration by one or more investors due to the withdrawal of amounts from tax-deferred vehicles, the apparatus including: a first computer tracking and communicating actual consideration withdrawn from tax-deferred vehicles to a digital electrical computer system which processes the actual consideration flows information in connection with consideration owed by reason of the actual consideration withdrawn to investors, performing an accounting for a first party which owes the consideration to one or more second parties and for the one or more second parties to whom the consideration is owed, wherein the accounting for the first party and the accounting for the second party are such as to allow a settlement, based on the consideration withdrawn, between the parties to the transaction to manage the actual flows of consideration, and produces an indication of at least one of: the amount owed by reason amounts withdrawn from tax-deferred vehicles, the identity of the recipients of the amounts owed and the settlement of amounts owed, and the remaining interest of at least one investor in amounts owed due to withdrawals of amounts from tax-deferred vehicles.

17. The apparatus of 16, further including the disbursement of amounts owed to one or more second parties

18. The apparatus of 16, further including the division of the right to receive consideration into different interests.

19. The apparatus of 18, further including the division of the rights to receive consideration into interests the performance of which will be based on differing criteria.

20. The apparatus of 16, further including tracking withdrawn from vehicles described in section 4975(e)(1)(A)-(C) of the Internal Revenue Code, as these section existed on Nov. 1, 2013.
